(19) United States
(12) Patent Application Publication
(10) Pub. No.: US 2014/0347853 A1
(43) Pub. Date: Nov. 27, 2014

(54) HIGH-POWER LED LUMINAIRE HAVING A MODULAR, EXPANDABLE MECHANISM

(71) Applicant: Luis Gerardo Aviña Silva, Tlajomulco de Zuniga (MX)

(72) Inventor: Luis Gerardo Aviña Silva, Tlajomulco de Zuniga (MX)

(21) Appl. No.: 14/344,340

(22) PCT Filed: Feb. 29, 2012
(86) PCT No.: PCT/MX2012/000021

§ 371 Date: Aug. 15, 2014

(30) Foreign Application Priority Data
Sep. 19, 2011 (MX) MX/A/2001/009774

(51) Int. Cl. F21S 8/00; F21V 19/00; F21V 31/00; F21K 99/00; F21V 15/01

(52) U.S. Cl. CPC F21S 8/00; F21K 9/10; F21K 9/50; F21V 15/01; F21V 31/00; F21V 19/003; F21Y 2101/02
USPC 362/240

(57) ABSTRACT

The invention relates to a high-power LED luminaire for public lighting. The use of individual diffusers for each LED makes it possible to obtain a light pattern similar to the I/SI type, which is ideal for public lighting. Every PCBA, which is supplied by a power controller, can be exchanged individually by means of a simple method that only requires removing the bottom lid of the luminaire, attachment means and a cover having built-in diffusers. Once said components have been removed, the PCBA can be unscrewed from the base thereof in order to be replaced. The top casing comprises outer and inner projections which improve the temperature exchange with the environment, reducing the operating temperature of the LEDs. The bottom lid has at least one groove that allows air to circulate, also reducing the operating temperature of the LEDs.

### TECHNICAL FIELD

The present invention pertains to a luminaire for public lighting that is composed of electronic cards of the PCBA type (their English initials), which are installed inside a housing, it being possible to insert, eliminate, and expand the necessary number of them, whether one or more types of LEDs or variants thereof, to provide different lighting intensities. Covers having one or more light diffusers enclose the PCBA electronic cards. The covers help project the luminous flux of the LEDs to the outside of the luminaire, providing the necessary luminous flux to illuminate the desired area. The diffusers are of parabolic shape, which helps the luminous flux to be projected to the surface being illuminated. The diffusers can have one or more types of curvature, which differ from each other due to their geometry, so that I consider my invention to lie primarily in the technical mechanical and obviously the electrical/electronic field; nevertheless, I suggest that it be evaluated in the mechanical field, since the electronic circuit in itself is not the subject of the present application.

These areas of engineering, taken together, should help provide a better alternative for the development of a family of light-emitting diode (LED) high-power luminaires to achieve a high level of light. To achieve the best efficiency and performance of the product, the necessary steps will be taken to provide a product with a sufficient level of heat transfer, insulation of electronic components, electrical safety, and the best possible direction of the luminous flux emitted from the high-power LEDs.

### PRIOR ART

At present, metal-additive, magnetic-induction, fluorescent, mercury-vapor and sodium-vapor luminaires as well as incandescent bulbs are used for purposes of public lighting in Mexico and other countries around the world. Even though the metal-additive, magnetic-induction and sodium-vapor luminaires (high and low pressure) have shown advantages in comparison with some of the technologies employed in public lighting, these benefits have been surpassed by the high-power LED technology in certain cases. This technology requires one or more LED(s) to be employed to provide the required quantity of light to illuminate a specific area. There are certain characteristics that are required to provide the desired level of illumination, efficiency, and performance. Among other things, the following are some of the requirements for achieving an optimal design: Effective transfer of heat to prevent the high-power LEDs from overheating. Generally the absence of an adequate heat dissipation system increases the possibility of the LEDs becoming overheated, which causes a decline in their performance (causing a premature failure), the brightness and color are altered, and their service life is decreased unless the problem is handled promptly. Therefore, an optimal level of heat transfer is required to prevent the aforementioned problems. Also the electronic circuits, electronic cards, power sources are affected if there is a high level of moisture, dust or other type of contaminant inside the luminaires. Typically, these external agents need to be isolated from the electronic components to obtain an optimal performance. For this reason, the components of our luminaires have been designed to limit as much as possible the presence of these contaminants. In some cases, these contaminants cause corrosion and short circuits, which significantly reduce the service life of the product. Another important aspect in the service life of the LEDs is the current provided to them. Therefore, it is of extreme importance to use power sources with constant current to avoid sudden changes in current and thus assure the service life of the LEDs. Lighting technology based on high-power LEDs has shown a significant reduction in electric power consumption, increased the quality of light, and decreased the production of heat and contaminants. At present, there are companies in various countries of the world that develop and manufacture high-power LED lamps and luminaires. Some examples of high-power LED luminaires on the market are the following: CN20082172829; CN20091239635; CN201368534; CN201001229; CN201259154; the aforementioned technologies have been included as a reference, since they make use of the LED technology. The lamps or luminaires covered in the aforementioned patents include chassis and housings of aluminum, arrangements of LEDs in distinct configurations which are assembled on the printed circuit electronic PCBA cards, which in turn are components of said products. Together with the PCBA cards, which include the high-power LEDs, components with reflecting surfaces and lenses are used to obtain the desired distribution and orientation of the luminous flux. Typically, this type of product uses heat dissipaters in the form of fins, which facilitate the heat transfer from the luminaire to the surroundings and in turn prevent the LEDs from overheating and failing prematurely. Even so, the products on the market lack the ability for changing the PCBA cards if they become damaged. Our luminaires are designed so that the electronic cards can be changed if they get damaged and eliminate the risk of total loss of operation of the luminaire. That is, our invention has the ability for continuous functioning even if one or more PCBA cards is (are) damaged. The intensity and density of the luminous flux will be affected by the absence of the disabled LEDs, but the luminaire will not stop working overall, thus avoiding the purchase and installation of a new luminaire. It should also be mentioned that the capacity of the luminaires can be adjusted to the needs of the customer, since the minimum capacity of the luminaires will be 1 Watt and it could be increased to satisfy the specific need of the customers. This will be of great benefit, since the luminaires could be adapted to the need required by the customer without it being necessary to use a product of higher power than what is required, or even worse, to use a product not having sufficient capacity to illuminate the desired area and endangering the safety of the inhabitants or visitors of a town or community.

In the journal MULTIPLICA construcción, arquitectura y urbanismo, pp. 22 and 23 of JULY 2011, corresponding to Vol. 6 No. 63, and on line at www.revistamultiplica.com, there is presented an article published by Manuel Huerta Galván and Alfonso Pimentel Castellón, criticizing the performance of LED technology for public lighting, defining a series of problems of the luminaires in public lighting due to the fact that the College of Mechanical Engineers and Electricians of Jalisco (hereinafter, CIMEJ) criticized the use of products making use of LEDs. The CIMEJ used as its reference the luminaires making use of this technology in some avenues or streets of Guadalajara, or municipalities like Chapala, Cocula, among others, arguing that the following reasons for failure exist for the installation of LED technology in public lighting, namely (VERBATIM):
a) Considering the parameters of luminous flux emitted (Im/W) and service life, with the values indicated by the manufacturers of LEDs, values which are calculated in nominal conditions of 25 degrees Centigrade, but during the operation of the LED in a luminaire the latter is heated and depends on the mechanical design for dissipating the heat generated, these values are seriously affected to such an extent that before reaching ten percent of the service life in question the luminous flux was already only 51 percent;
b) As for the levels of illuminance and uniformity, it was determined that basically they do not meet the requirements of the NOM (official Mexican standard) and that given the decrease in the luminous flux at present, the peripheral traffic safety [main traffic artery of the city of Guadalajara] has critical and highly dangerous levels of illuminance;
c) Failure to keep promises in regard to service life and efficiency, due primarily to the poor heat management and the use of low-quality “drivers”;
d) And, on the other hand, in regard to lighting engineering aspects such as the use of heat temperatures that are too cold, excess lighting or poor uniformity, among other things.

As can be seen, the engineers have identified the problems which this technology solves and which furthermore represents a solution that anticipated this very publication.

Based on the development of the technology, one can present as the advantages of the high-power LED luminaire having a modular, expandable mechanism:
1. Low consumption of light.
2. Service life of 50,000 hours or more.
3. Does not contain heavy metals (lead, mercury, tin, etc.)
4. Easy installation.
5. PCBA cards with interchangeable high-power LEDs.
6. Minimal heat emission.
7. Biodegradable components.
8. Easy assembly.
9. Fast response to the electric current.
10. No warm-up prior to use.

### DESCRIPTION

The high-power LED luminaire having a modular, expandable mechanism shall be described in detail in the following description and presented in the figures included in this document. The figures presented are merely a reference and should not be considered as a limitation, but only a listing.

### BRIEF DESCRIPTION OF THE FIGURES

FIG. 1 is a conventional, perspective view from above of a PCBA card.

FIG. 2 is a lateral view of a PCBA card.

FIG. 3 is a longitudinal section of a PCBA card.

FIG. 4 is a top view of a PCBA card

FIG. 5 is a bottom view of a PCBA card

FIG. 6 is a front view of a PCBA card

FIG. 7 is a conventional, perspective view from above of a variant of a PCBA card

FIG. 8 is a lateral view of a variant of a PCBA card

FIG. 9 is a longitudinal-sectional of a variant of a PCBA card

FIG. 10 is a top view of a variant of a PCBA card

FIG. 11 is a bottom view of a variant of a PCBA card

FIG. 12 is a front view of a variant of a PCBA card

FIG. 13 is a conventional, perspective view from above of the cover with diffusers.

FIG. 14 is a front view of the cover with diffusers.

FIG. 15 is a lateral view of the cover with diffusers.

FIG. 16 is a top view of the cover with diffusers.

FIG. 17 is a bottom view of the cover with diffusers.

FIG. 18 is a cross-sectional view of the cover with diffusers.

FIG. 19 is a longitudinal-sectional view of the cover with diffusers.

FIG. 20 is a conventional, perspective close-up and cropped view of variants of the concave surface of the parabola of the diffuser.

FIG. 21 is a conventional perspective view of the assembled luminaire.

FIG. 22 is a front view of the assembled luminaire.

FIG. 23 is a rear view of the assembled luminaire.

FIG. 24 is a lateral view of the assembled luminaire.

FIG. 25 is a top view of the assembled luminaire.

FIG. 26 is a bottom view of the assembled luminaire.

FIG. 27 is a conventional, perspective cutaway view of the luminaire from above.

FIG. 28 is an enlarged, longitudinal-sectional view of the luminaire

FIG. 29 is a conventional, perspective view of the bottom lid

FIG. 30 is a front view of the bottom lid

FIG. 31 is a rear view of the bottom lid

FIG. 32 is a lateral view of the bottom lid

FIG. 33 is a top view of the bottom lid

FIG. 34 is a bottom view of the bottom lid

FIG. 35 is a top view of the base for PCBA cards, the bottom view being substantially the same

FIG. 36 is a conventional, perspective view of the power source

FIG. 37 is a lateral view of the power source

FIG. 38 is a top view of the top lid

FIG. 39 is a bottom view of the top lid

FIG. 40 is an enlarged, lateral view of the “gland type” connector

FIG. 41 is a conventional, perspective view of the multiple connector

FIG. 42 is a lateral view of the multiple connector

FIG. 43 is a front view of the multiple connector

FIG. 44 is a conventional, perspective view of the lateral cover from above

FIG. 45 is a close-up, bottom, sectional view with variants of the cavities of the cover with diffusers for the PCBA cards

FIG. 46 is a close-up, bottom, sectional view with variants of the PCBA cards

FIG. 47 is a conventional, perspective, close-up and sectional view of the luminaire from the bottom

FIG. 48 is a conventional, perspective, bottom view with frontal cross section of the luminaire

FIG. 49 is a conventional, perspective, exploded view of the luminaire

FIG. 50 is a conventional, perspective view of the luminaire, showing the covers with diffusers in the housing and the lateral covers

FIG. 51 is a top view of a PCBA card with cover with diffusers and some lids for diffusers

FIG. 52 is a conventional, perspective view of a PCBA card with cover with diffusers and some lids for diffusers

FIG. 53 is a conventional, perspective view of a PCBA card with cover with diffusers and without the lids for diffusers where no LEDs are present

FIG. 54 is a front view of a PCBA card with cover with diffusers and without the lids for diffusers where no LEDs are present

FIG. 55 is a longitudinal section view of a PCBA card with cover with diffusers having diffusers and without the lids for diffusers where no LEDs are present

FIG. 56 is a front view with cross section of a PCBA card with cover with diffusers with diffusers and without the lids for diffusers where no LEDs are present

FIG. 57 is a front view with cross section of the housing and the bottom lid showing the protuberance and channel for hermetically sealing the luminaire

FIG. 58 is a front view with cross section of the bottom lid, showing the protuberance that is inserted into the channel for hermetically sealing the luminaire

FIG. 59 is a front view with cross section of the housing, showing the channel serving as the plug-in for the protuberance of the bottom lid

FIG. 60 is a bottom view of the assembled luminaire, showing the mesh that will serve to isolate the inside of the luminaire from the surroundings.

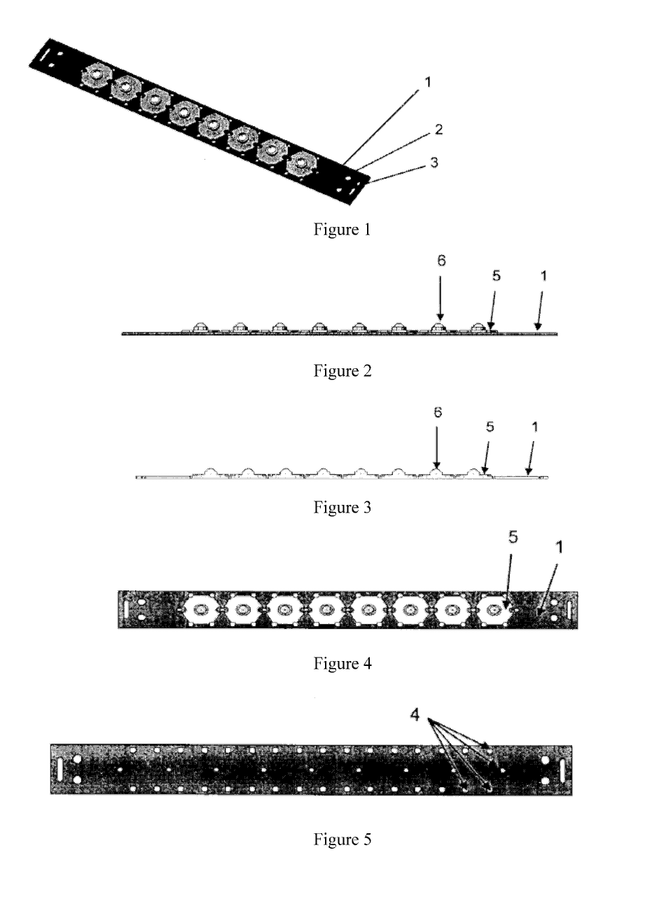

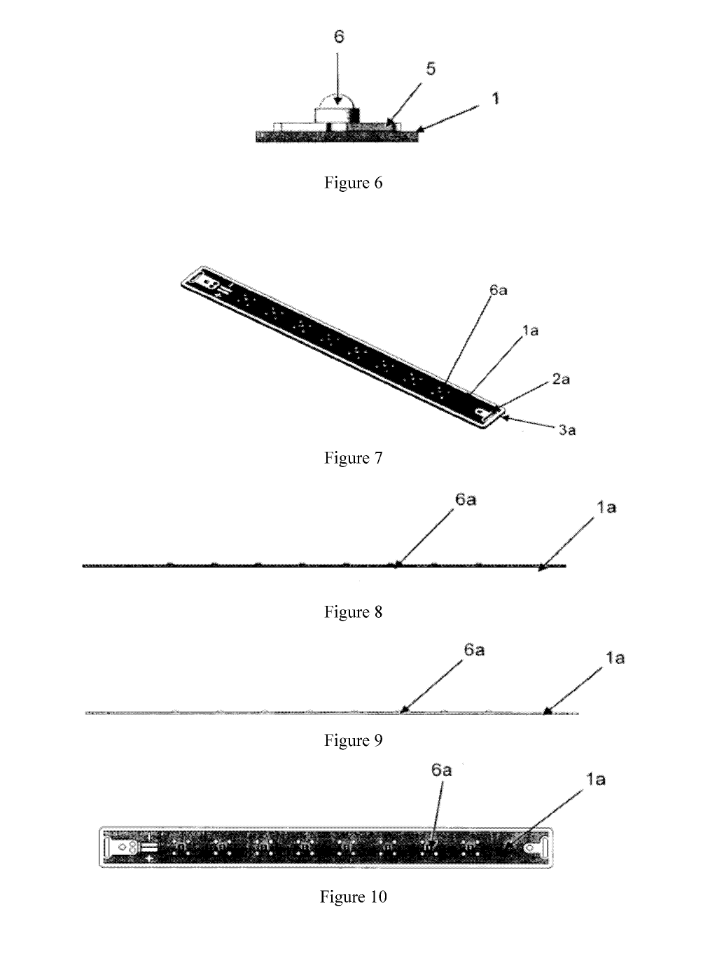

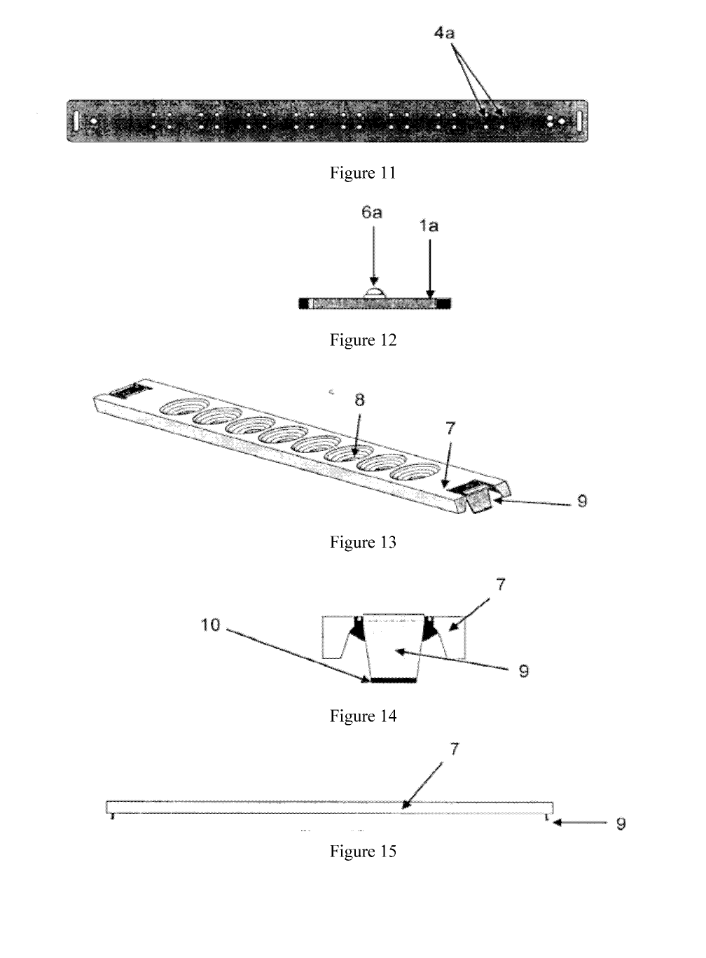

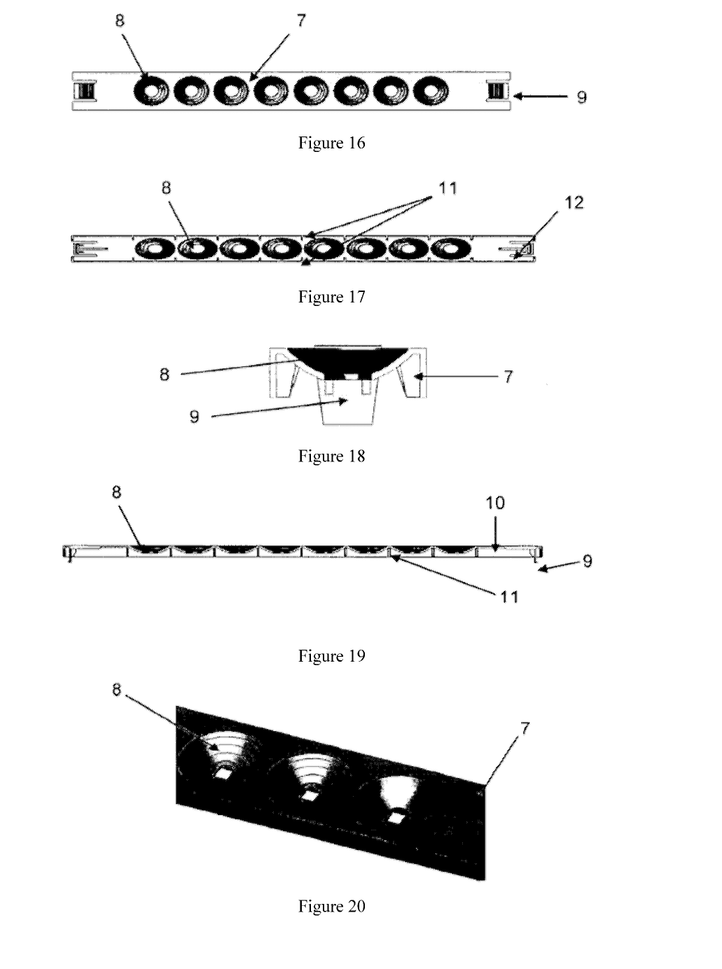

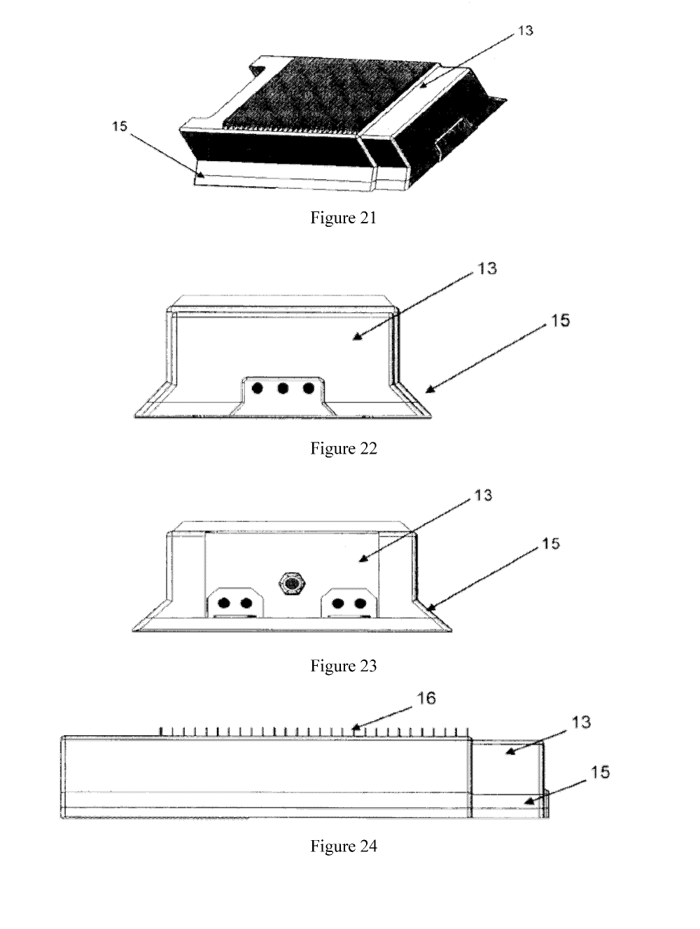

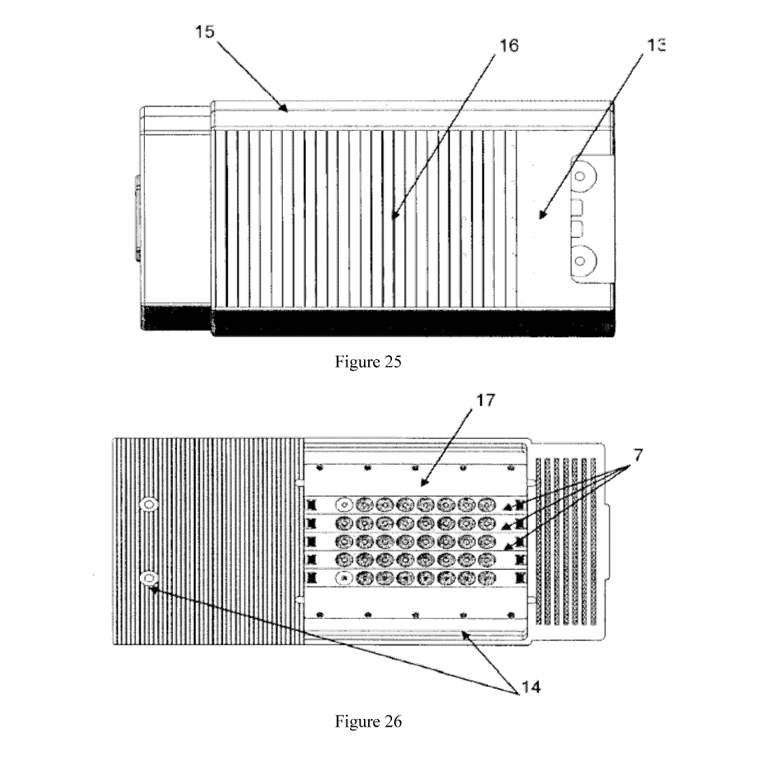

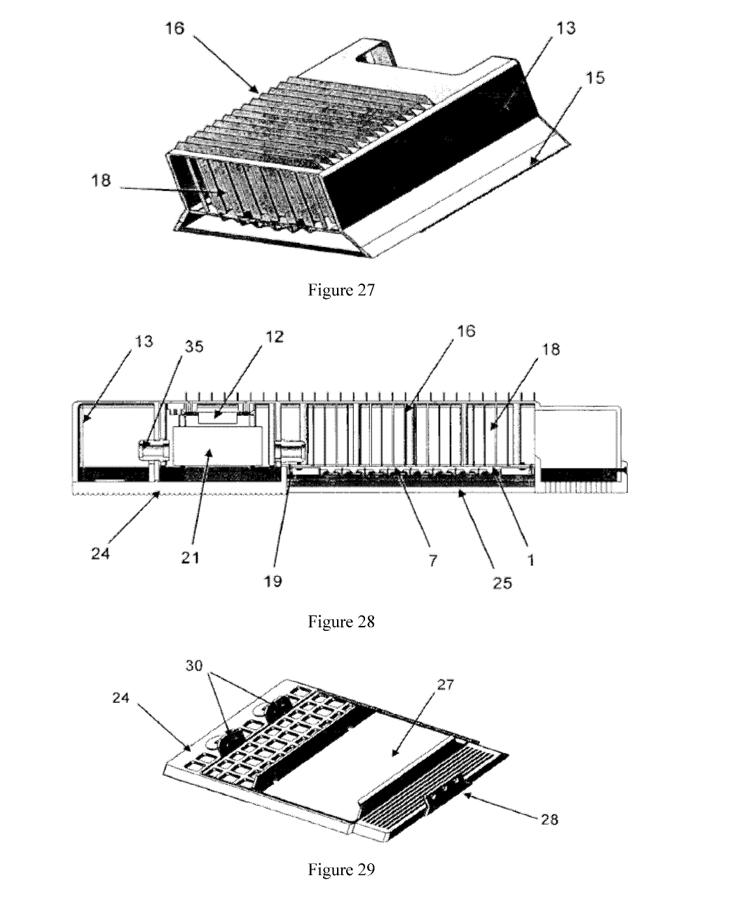

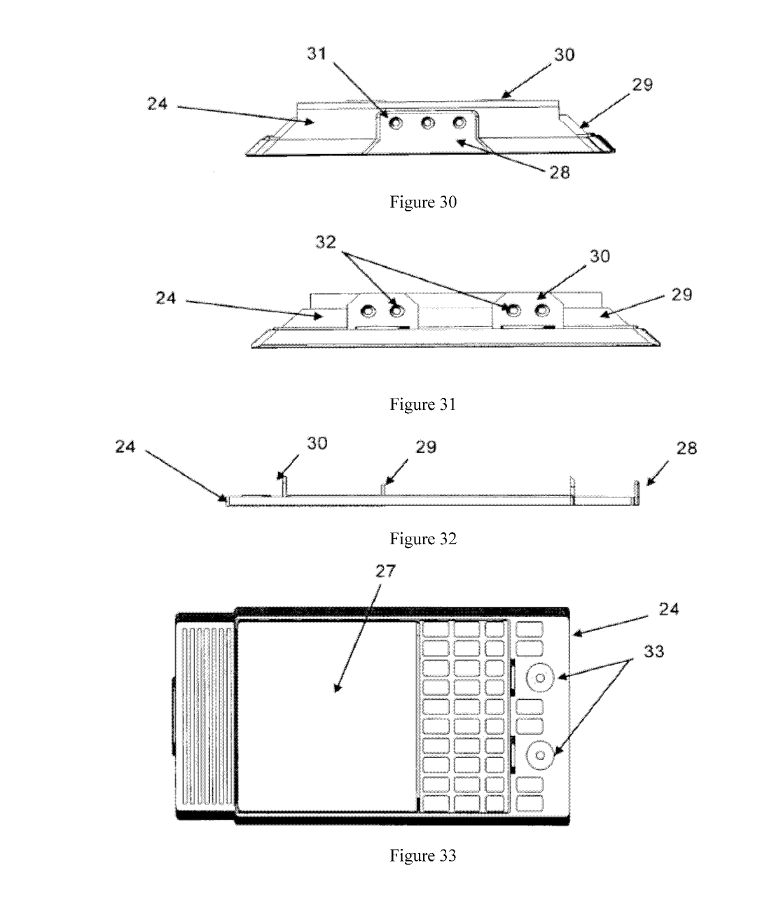

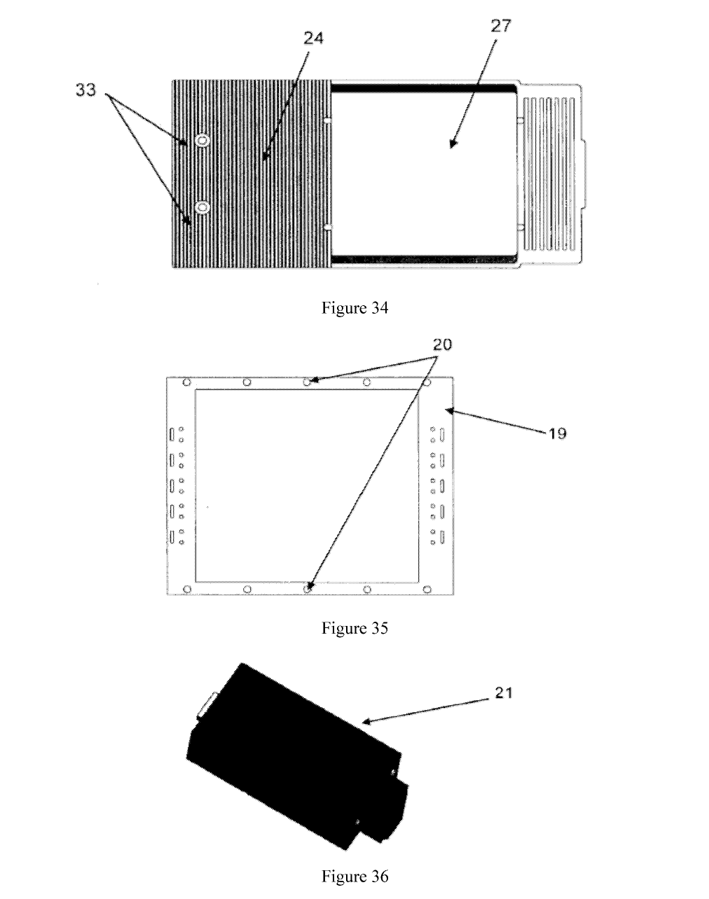

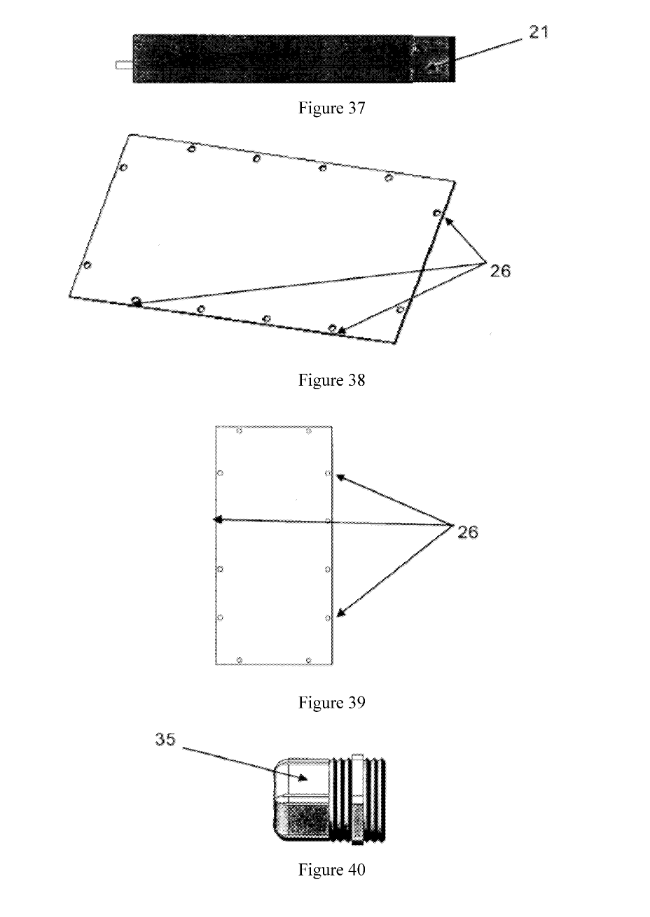

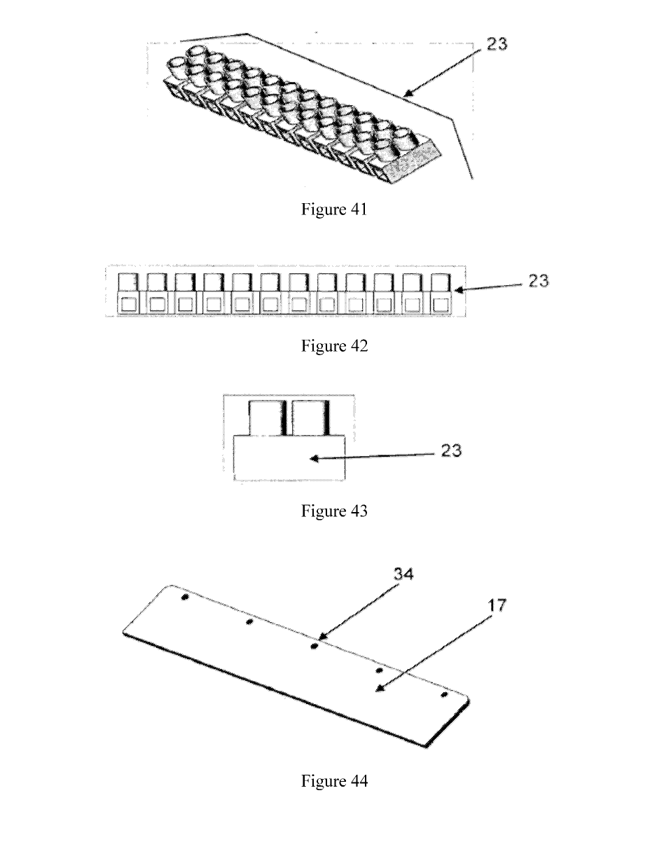

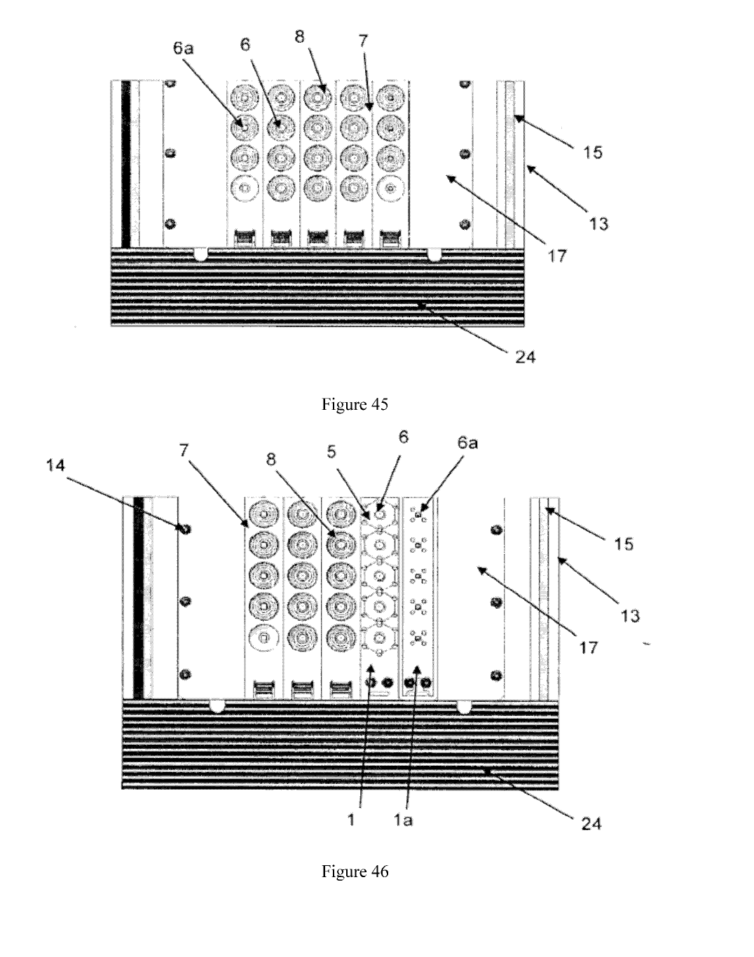

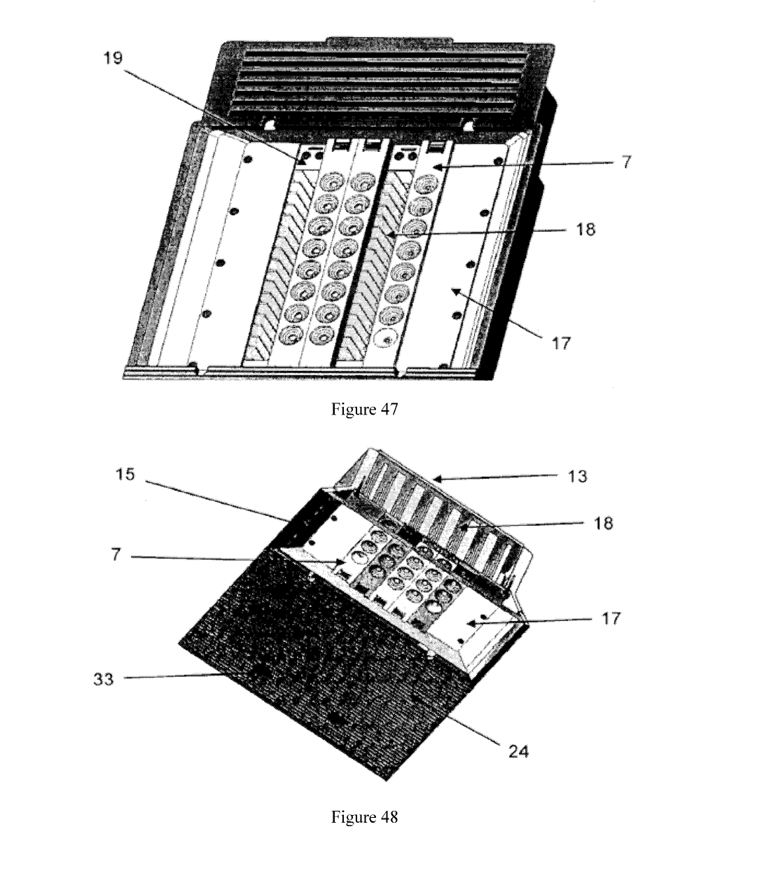

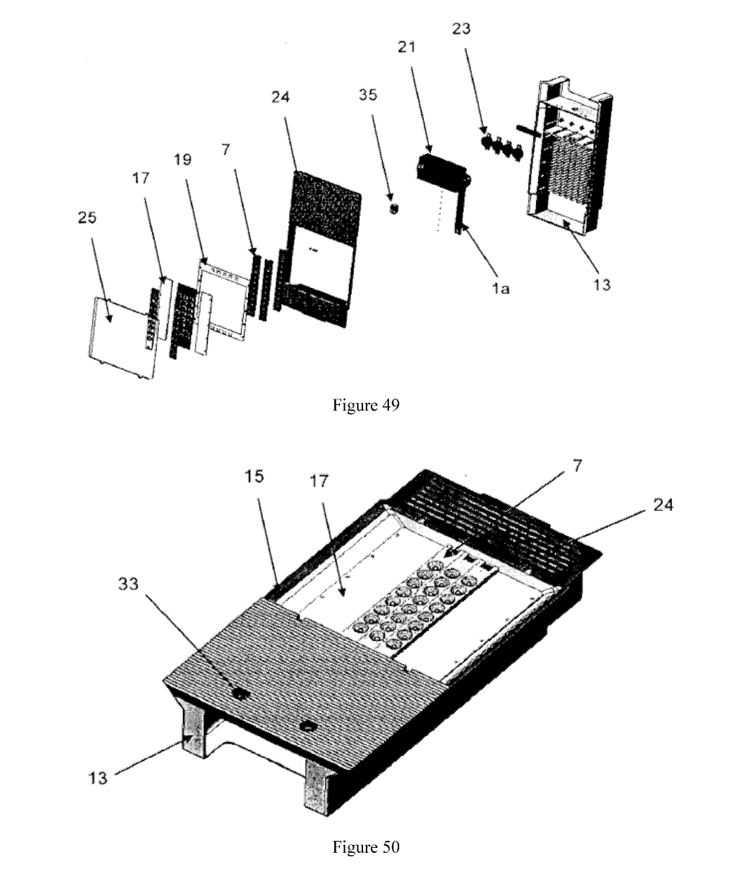

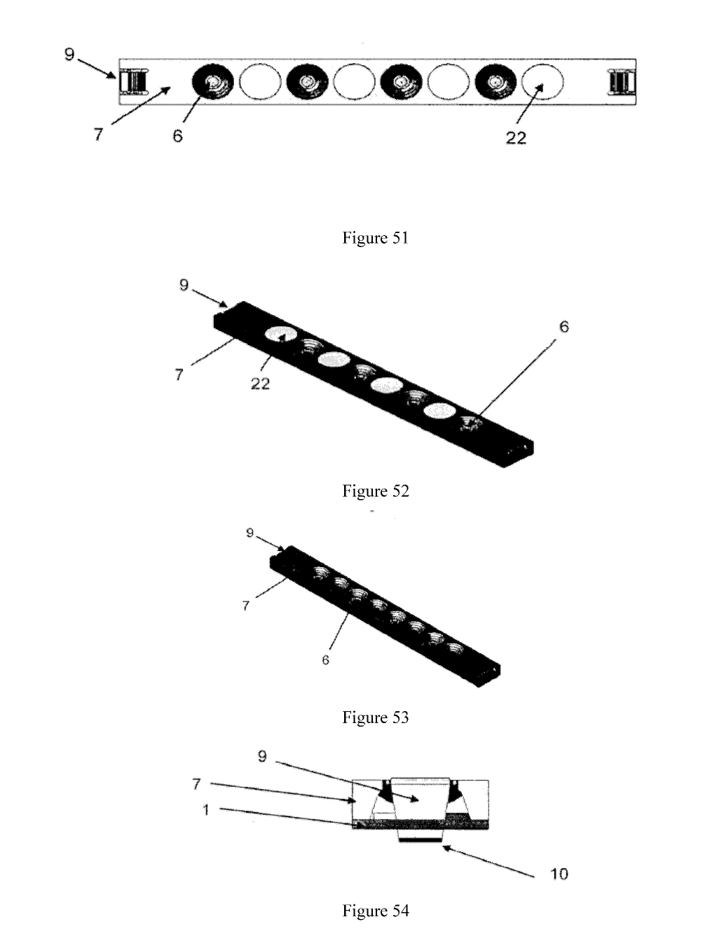

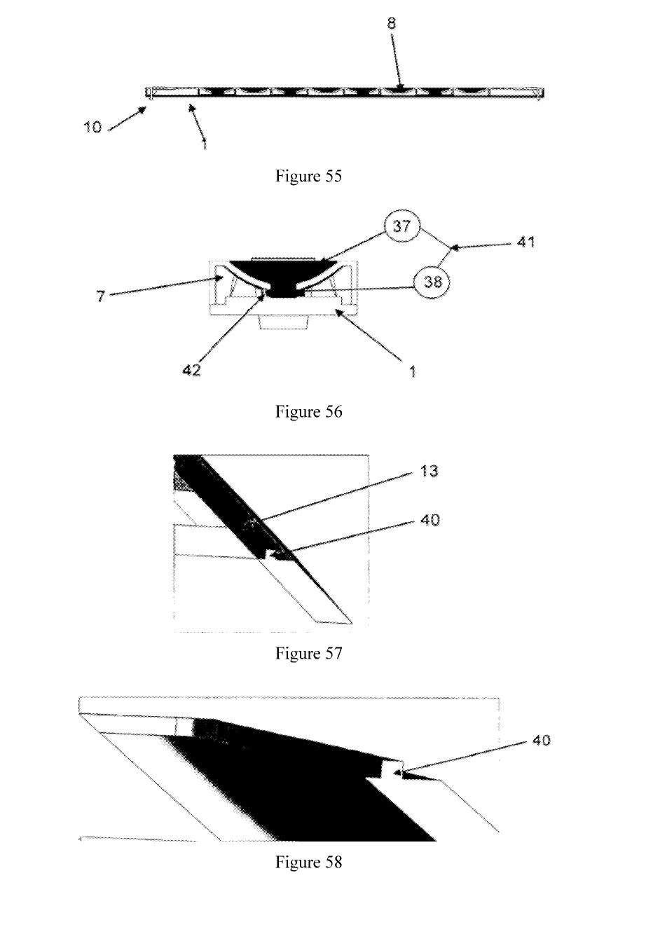

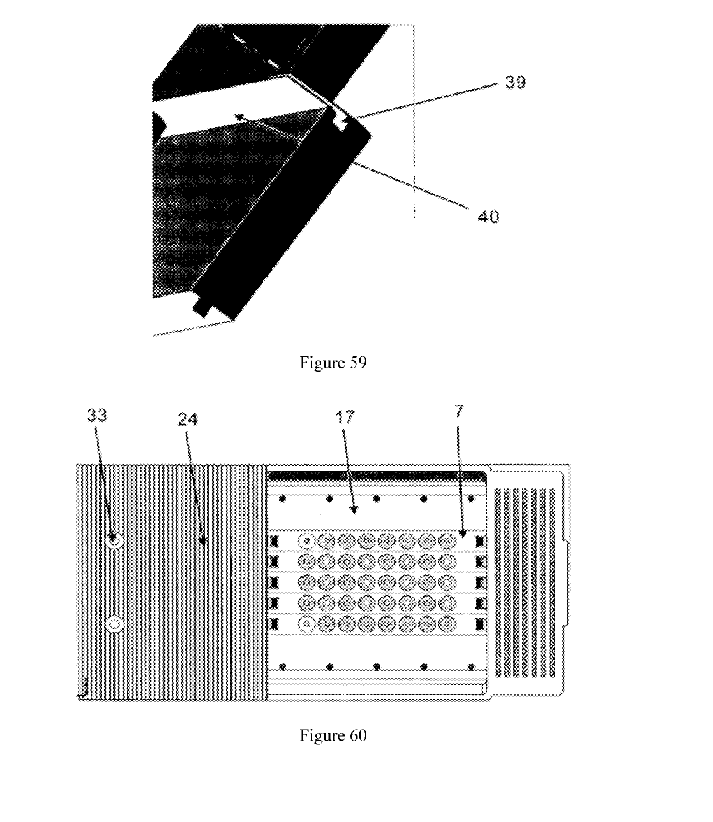

Based on the above figures, the high-power LED luminaire having a modular, expandable mechanism comprises at least one electronic card of PCBA type 1 with a pair of perforations 2 at each end for fastening to the PCBA card base 19, followed by a groove 3 where the perpendicular projection 9 of the cover 7 passes through the electronic card 1, and the groove 3 of the PCBA card base 19; in the electronic card 1, there is arranged in hexagonal shape at least one group of perforations 4 that are equidistant with respect to the center of the group and that by their arrangement along the card 1 share an opening with the adjacent group, these groups of perforations 4 accommodate the same number of high-power LEDs 6; the LED base 5 functions as a heat dissipater, since it is made of heat-conducting material (preferably aluminum); and said bases 5 are distributed along the card 1, coinciding with the group of perforations 4 and the number of high-power LEDs 6 per card 1.

A variant of the above-described card is composed of an electronic card 1a with one perforation 2a at each end for fastening to the PCBA card base 19, followed by a groove 3a where the projection 9 of the cover 7 passes through the electronic card 1a and the PCBA card base 19; in the electronic card 1a, there is arranged in quadrangular shape at least one group of perforations 4a that are equidistant with respect to the center of the group and that by their arrangement along the card 1a these groups of perforations 4a accommodate the same number of high-power LEDs 6a; the bottom part of the LED functions as a thermal insulator, since it is made of a material not conducting heat (preferably ceramic); the LEDs are distributed along the card 1a, coinciding with the group of perforations 4a and the number of high-power LEDs 6a per card 1a.

On top of any one of the previously described cards 1 is placed a cover 7 with diffusers 8 of parabolic shape, which coincide with the number of high-power LEDs 6 or 6a of the card 1 or 1a; the diffusers have a perforation that coincides with the shape of the LED 6 or with the bottom part of the LED 6a and allows optimizing the light beam which they emit, since the diffuser 8 is positioned exactly where the lens of the LED 6 or 6a begins; the cover 7 furthermore has at each end a projection 9 that is prolonged perpendicularly from the surface of the cover 7 and toward the outside of same, ending in a notch 10 which holds the cover 7 in the PCBA card base 19, passing through the grooves 3 or 3a of the PCBA card 1 or 1a and the PCBA card base 19, respectively, when the cover 7 is inserted by press-fitting; at the internal part of the cover 7 between each diffuser 8 on top of the walls of the cover 7 there is at least one pair of reinforcements 11 to provide firmness and stability to the cover 7 which on its upper internal surface has at least one longitudinal reinforcement 12 which extends over the upper internal surface of the cover 7 as far as the perpendicular projection 9; the concavity of the parabola is calculated by a predefined algorithm which optimizes the direction of the light and its orientation, the parabola having been developed so as to have at least five cardinal positions which aided the development of the surface of parabolic shape of the diffusers which help orient the light beam coming from the LEDs 6 or 6a.

Using the perforations of the ends 2 or 2a of the cards 1 or 1a, respectively, which are fastened to the PCBA card base 19 by a fastening means 14 such as screws, rivets, plugs, conventional fasteners, posts, pivots, etc., preferably being removable to enable replacing at least one or more of the electronic cards when it is necessary to provide technical maintenance or replace some of the PCBA cards 1 or 1a and thereby prolong the service life of the technology; the housing 13 has the shape of a quadrangular prism with side walls 15 inclined at 45 degrees, which has a twofold purpose: first, to direct the flow of water to the sides of the luminaire when it is in contact with this liquid, and secondly, to force the majority of light coming from the LEDs to the outside of the luminaire; on its internal part, these walls are completely smooth, which helps to reflect the light beams emitted by the LEDs 6 or 6a; on the upper outer part of the housing 13, there are located multiple heat dissipaters 18 of rectangular form, which extend from the upper surface of the housing 13; the internal dissipaters are separated along two axes (x, y) so that the air flow coming from the outside of the luminaire reduces their temperature and consequently the dissipaters reduce the temperature of the electronic cards, which are located in the bottom part of said quadrangular dissipaters; adjacent to said heat dissipaters 18 is placed the PCBA card base 19, which has threaded perforations of two diameters, which will enable a fastening of the PCBA card base 19 to the housing 13; and, on the other hand, the electronic cards 1 or 1a can be fastened to the PCBA card base 19, the first perforations coinciding with the perforations 2 or 2a through which passes the fastening means 14 that supports the cards 1 or 1a, respectively, and the second perforations of the PCBA card base 19 coinciding with the perforations 20 for fastening the PCBA card base 19 to the housing 13 with similar fastening means 14; the housing 13 furthermore has two internal walls which contain an opening in which is inserted a “gland type” connector 35; in the rear part of the housing 13 through said connector pass the cables of the lamp post to supply the power source 21; a second “gland type” connector which is inserted in the second internal wall of said connector is used to pass from one side to the other the cables of the current controllers that supply the PCBA cards 1 or 1a; both walls and the top lid 25 are used to segregate the power source 21, the current controllers 22 and multiple connectors 23 from the rest of the luminaire; the top lid 25 has twelve passage holes 26 through which pass the fastening means 14 that secure it to the housing 13; in the lower part of the housing 13 there is located a channel 39; the bottom lid 24 has a quadrangular protuberance 40, which, together with the channel, help prevent water or some other liquid from seeping into the luminaire; the channel 39 and the protuberance 40 make contact once the housing 13 and the bottom lid 24 are assembled; in the central section of the housing 13 a transparent screen 25 (preferably of ultra-transparent material) will be joined to the bottom lid 24 which is secured by fastening means 14; the bottom lid 24 will be joined to the housing 13 to enclose the entire luminaire; the bottom lid 24 has a quadrangular opening 27 which allows the luminous flux emitted by the LEDs 6 or 6a to exit from the inside of the luminaire; the bottom lid 24 has at least four protuberances which couple to the bottom part of the housing 13, the first of them being in front 28 with perforations 31 to allow the passage of the fastening means, the second one being intermediate 29, and the two parallel rear ones 30 also having perforations 32 to allow the passage of the fastening means 14, making it possible to close the luminaire completely; moreover, the bottom lid 24 has at its rear end two perforations 33 through which pass a pair of fastening means 14 (preferably screws with nuts), which will keep the luminaire fastened to the arm of the lamp post; when fewer cards 1 or 1a are required to be placed in the PCBA card base 19, the openings which appear due to the absence of cards are covered with a cover 17 which has perforations 34 to allow the passage of the fastening means 14 through the PCBA card base 19 and in this way to secure the covers to the housing 13; on occasion, some of the high-power LEDs 6 or 6a can be eliminated from the PCBA cards 1 or 1a by using a lid 41 to cover the space produced by the absence of the LEDs, the lid being composed of a flat surface 37 press-fitted in the upper part of the diffuser where there is no LED; in the upper part, the lid 41 is circular to seal the diffuser 8 without any LEDs; in the lower part, it has two circular protuberances which extend for a distance equivalent to the height of the diffuser 8, in order to seal the latter permanently; both protuberances have a notch 42, these being inserted into the bottom surface of the diffusers 8, preventing the lid 41 from being removed. The bottom lid 24 has at least one groove XX through which air from outside of the luminaire is introduced inside the luminaire and this is used to cool the electronic cards 1 or 1a; to prevent some external agent or contaminant from getting into the luminaire, the grooves xx are covered by a mesh xx in the top part of the bottom lid 24.

### SOME CONVENTIONAL VARIANTS OF THE LUMINAIRE

It is possible to control a certain number of high-power LEDs assembled on the electronic cards which are supplied by a power source with constant current and independent current controllers for each of the cards.

It is possible to control the luminaires by the use of sensors which can activate and deactivate the luminaires depending on the need for their use.

It is possible to control the capacity of the lamps by the use of PCBA electronic cards which are able to limit the current and thereby control the luminous flux to decrease the luminous intensity of the luminaire at times when maximum performance is not needed.

It is possible to control the internal temperature of the luminaire in a range favorable to the high-power LEDs by the use of a heat exchanger/cooling system. Said mechanism will contain a pump/compressor, a certain number of ducts, heat dissipaters and an additive/liquid that assists the heat transfer. The fluid through the ducts will help to maintain the internal temperature of the luminaire constant and thus extend the service life of the LEDs as much as possible.

It is possible to increase or decrease the amount of light reflected by the diffusers by using devices (lenses, diffusers, etc.) with different geometries or different types of coatings which help to channel the luminous flux emitted by the high-power LEDs.

It is possible to decrease the amount of contamination of the environment once the luminaire reaches the end of its life by the use of components made from polymers mixed with organic fibers for easy decomposition.

It is possible to decrease the amount of contamination once the PCBA electronic cards reach the end of their service life by the use of chemical compounds free of lead, mercury and tin to prevent the PCBA cards from polluting the environment if they are discarded by mistake. The electronic cards and electronic components should adhere to the RoHS methodology to ensure that the use of heavy metals is limited to an adequate level.

It is possible to reduce the amount of contamination once the luminaire reaches the end of its service life since the majority of its components will be manufactured from aluminum or polymers that can be recycled.

1-8. (canceled)

9. A high-power LED luminaire having a modular, expandable mechanism, of the kind having a cover with diffusers of parabolic shape having a perforation that coincides with the shape of the LED and allows an optimizing of the light beam which they emit, a housing with quadrangular protuberances in the bottom lid to prevent water seepage, a screen on its bottom lid, and a heat dissipation system in the housing with the shape of a quadrangular prism outside and inside, wherein there is placed a cover with a diffuser of parabolic shape, which coincides with the number of high-power LEDs in several PCBA cards, the diffusers having a perforation that coincides with the shape of the LED or with the base of the LED, allowing optimizing the light beam which they emit, since the bottom part of the diffuser is positioned exactly where the lens of the LED begins;
the cover furthermore has at each end a projection that is extended perpendicularly from the upper internal surface of the cover and toward the outside of same, ending in a notch that holds the cover in the PCBA card base, passing through the grooves of the PCBA cards and the PCBA card base, respectively, when the cover is inserted by means of pressing; at the internal part of the cover between each diffuser, on the walls of the cover, there is a pair of reinforcements to provide firmness and stability to the cover, which at its upper internal surface has a longitudinal reinforcement that extends over the surface as far as the perpendicular projection; the concavity of the parabola is calculated by a predefined algorithm that optimizes the direction of the light and its orientation, the parabola having been developed so as to have five cardinal positions which aided the development of the surface of parabolic shape of the diffusers which help orient and diffuse the light beams coming from the LEDs; using the perforations of the ends of the cards, respectively, which are fastened to the PCBA card base by a fastening means such as screws, rivets, plugs, conventional fasteners, posts, pivots, etc., preferably being removable to enable replacing an electronic card when it is necessary to provide technical maintenance or to replace some of the PCBA cards and thereby prolong the service life of the technology; the housing has the shape of a quadrangular prism with side walls inclined at 45 degrees, which has a twofold purpose: first, to direct the flow of water or other liquid to the sides of the luminaire when it is in contact with this liquid, and secondly, to force the majority of light coming from the LEDs to the outside of the luminaire; at its internal part, these walls have a smooth surface, which helps to reflect the light beams emitted by the LEDs; on the upper outer part of the housing, there are located multiple heat dissipaters in the shape of transverse fins, and, for the opposite part, that is, on the inside of the housing, there are located multiple heat dissipaters of rectangular form, which extend from the top surface of the housing; the internal dissipaters are separated along two axes (x, y) so that the air flow coming from the outside of the luminaire helps reduce their temperature and consequently they will reduce the temperature of the electronic cards, which are located in the bottom part of the quadrangular dissipaters; adjacent to the heat dissipaters is placed the PCBA card base, which has two types of threaded perforations of two different diameters, which will enable a fastening of the PCBA card base to the housing, and, on the other hand, the electronic cards can be fastened to the PCBA card base by similar fastening means; the housing furthermore has two internal walls which each contain an opening in which is inserted a “gland type” connector; in the rear part of the housing, through the connector, pass the cables of the lamp post to supply the power source, a second “gland type” connector being inserted in the second internal wall and being used to pass from one side to the other the cables of the current controllers which supply the PCBA cards; both walls and the top lid are used to segregate the power source, the current controllers and multiple connectors from the rest of the luminaire; the top lid has twelve passage holes through which pass the fastening means which secure it to the housing; in the lower part of the housing, there is located a channel, and the bottom lid has a quadrangular protuberance, which together with the channel, helps prevent water or some other liquid from seeping into the luminaire; the channel and the protuberance make contact once the housing and the bottom lid are assembled; in the central section of the bottom lid, a transparent screen (preferably of ultra-transparent material) will be joined, which is secured by fastening means; in this same area, there is a quadrangular opening which allows the luminous flux emitted by the LEDs to exit from the inside of the luminaire; the bottom lid is joined onto the housing to enclose the entire luminaire; the bottom lid has four protuberances which couple to the lower part of the housing, the first of these being in front with perforations to allow the passage of the fastening means, the second one being intermediate, and the two parallel rear ones also having perforations to allow the passage of the fastening means, making it possible to close the luminaire completely; moreover, the bottom lid has at its rear end two perforations through which pass a pair of fastening means (preferably screws with nuts), which will keep the luminaire fastened to the arm of the lamp post; when fewer cards are required to be placed in the PCBA card base, the openings caused by the absence of the electronic cards are covered by the use of covers which have perforations to allow the passage of the fastening means and in this way secure them to the PCBA card base and subsequently to the housing; on occasion, some of the high-power LEDs can be eliminated from the PCBA cards by using a lid to cover the space produced by the absence of the LEDs, which is composed of a flat surface press-fitted in the upper part of the diffuser where there is no LED; in the top part, the lid is circular in order to seal the diffuser that lacks LEDs, and in the lower part, it has two circular protuberances which extend for a distance equivalent to the height of the diffuser; in order to be able to seal the latter permanently, both protuberances have a notch, which is inserted into the bottom surface of the diffusers, preventing the lid from being removed.

10. The luminaire of claim 9 further comprising an electronic card of the PCBA type with a pair of perforations at each end for fastening to the PCBA card base, followed by a groove where the perpendicular projection of the cover is inserted; on the card, there is arranged in hexagonal shape a group of perforations that are equidistant with respect to the center of the group and that by their arrangement along the card one of them is shared with the adjacent hexagon; these groups of perforations accommodate the same number of high-power LEDs; the LED base functions as a heat dissipater, since it is made of heat-conducting material (preferably aluminum); and the bases are distributed along the card, coinciding with the group of perforations and the number of high-power LEDs per card.

11. The luminaire of claim 9 wherein the LED base functions as a heat dissipater, since it is made of a heat-conducting material.

12. The luminaire of claim 9 wherein the LED base functions as a thermal insulator, wherein the material is ceramic.

13. The luminaire of claim 9 further comprising an electronic card of the PCBA type with one perforation at each end for fastening to the PCBA card base, followed by a groove where the projection of the cover is inserted; on the card, there is arranged in quadrangular shape a group of perforations that are equidistant with respect to the center of the group and that by their arrangement along the card these groups of perforations accommodate the same number of high-power LEDs; the bottom part of the LED now functions as a thermal insulator, since it is made of a material not conducting heat (preferably ceramic); the LEDs are distributed along the card, coinciding with the group of perforations and the number of high-power LEDs per card.

14. The luminaire of claim 13 where the LED base functions as a heat dissipater, wherein the material is aluminum.

15. The luminaire which employs PCBA cards, which support a device with integrated diffusers because the perforation of the diffuser base coincides in its dimension and shape with the LED where it is inserted to optimize the light beam, of claim 9, where the concavity of the parabola is calculated by a predefined algorithm that optimizes the direction of the light and its orientation, wherein the modification of the focus of the parabola has five positions on the vector orthogonal to the luminous flux of the LED.

16. The luminaire of claim 15 wherein the modification of the focus of the parabola has no more than five positions on the vector orthogonal to the luminous flux of the LED.

17. The luminaire which employs PCBA cards of claim 9 wherein the modification of the focus of the parabola has twenty-five positions on the vector orthogonal to the luminous flux of the LED.

18. The luminaire of claim 9 wherein the parabola has no more than five cardinal positions which aided the development of the surface of parabolic shape of the diffusers which help orient and diffuse the light beams coming from the LEDs.
